(19) United States
(12) Patent Application Publication
(10) Pub. No.: US 2014/0033057 A1
(43) Pub. Date: Jan. 30, 2014

(54) METHOD, APPARATUS, AND SYSTEM FOR MANAGING INFORMATION IN A MOBILE DEVICE

(71) Applicant: Tencent Technology (Shenzhen) Company Limited, Shenzhen (CN)

(72) Inventor: Lichun ZHANG, Shenzhen (CN)

(73) Assignee: Tencent Technology (Shenzhen) Company Limited, Shenzhen (CN)

(21) Appl. No.: 14/040,454

(22) Filed: Sep. 27, 2013

Related U.S. Application Data
(63) Continuation of application No. PCT/CN2013/079792, filed on Jul. 22, 2013.

(30) Foreign Application Priority Data
Jul. 23, 2012 (CN) 201210255764.6

(51) Int. Cl. H04W 48/20; G06F 3/048

(52) U.S. Cl. CPC H04W 48/20; G06F 3/048
USPC 715/738

(57) ABSTRACT

The present invention discloses a method, an apparatus, and a system for managing information in a mobile device having one or more processors and memory for storing program modules to be executed by the processors. The mobile device is connected to a computer through a wireless local area network (WLAN). The method includes: sending, by the mobile device, local device management information to the computer through the WLAN, wherein the local device management information is used by the computer for generating a graphical user interface to a user of the computer; receiving, by the mobile device, information management instructions, wherein the information management instructions are generated by the computer based on user inputs through the graphical user interface; and managing, by the mobile device, information in the mobile device according to the information management instructions. The apparatus and the system include modules and programs to implement the method.

### RELATED APPLICATIONS

This application is a continuation application of PCT Patent Application No. PCT/CN2013/079792, entitled “METHOD, APPARATUS, AND SYSTEM FOR MANAGING INFORMATION IN MOBILE DEVICE,” filed on Jul. 22, 2013, which claims priority to Chinese Patent Application No. 201210255764.6, entitled “METHOD, APPARATUS, AND SYSTEM FOR MANAGING INFORMATION IN MOBILE DEVICE”, filed on Jul. 23, 2012, both of which are incorporated by reference in their entirety.

### TECHNICAL FIELD

The disclosed implementations relate generally to the field of communication technologies, and in particular, to a method, an apparatus, and a system for managing information in a mobile device.

### BACKGROUND

With the development of communication technologies, mobile devices, such as a cell phones or PDA (Personal Digital Assistant), have more and more functions. A user may not only make calls and send short messages through a mobile device, but also install various applications in the mobile device to implement various capabilities. As the mobile device has more functions, it carries more information items such as applications, address books, and short messages, and management of the information in the mobile device, such as deleting a short message, moving or uninstalling an application program, and editing an address book, needs to be conducted efficiently. In addition to managing information in a mobile device through the mobile device itself, to improve efficiency, a computer is usually used.

At present, when a computer is used to manage information in a mobile device, the process is as follows:

The computer is connected to the mobile device through a physical data line; a mobile device driver and mobile device information management software are installed in the computer; and the information in the mobile device is managed in the computer through the mobile device information management software.

However, in the implementation process of the present invention, the inventor finds that the existing technology has at least the following problems:

A mobile device driver and mobile device information management software must be installed in a computer, so that information in a mobile device can be managed, which leads to a cumbersome process and low efficiency.

### SUMMARY

To solve the problem of the existing technology, some embodiments of the present invention provide a method, an apparatus, and a system for managing information in a mobile device. The technical disclosures include at least:

A method for managing information in a mobile device is provided. The mobile device has one or more processors and memory for storing program modules to be executed by the one or more processors, and the mobile device is connected to a computer through a wireless local area network (WLAN). The method includes:

sending, by the mobile device, local device management information to the computer through the WLAN, wherein the local device management information is used by the computer for generating a graphical user interface to a user of the computer;

receiving, by the mobile device, information management instructions, wherein the information management instructions are generated by the computer based on user inputs through the graphical user interface; and

managing, by the mobile device, information in the mobile device according to the information management instructions.

An apparatus for managing information in a mobile device includes:

one or more processors;

memory; and

one or more modules stored in the memory and to be executed by the one or more processors, the one or more modules including:
a connecting module, configured to connect the mobile device to a WLAN;
an information transfer module, configured to send local device management information of the mobile device to a computer through the WLAN, wherein the local device management information is used by the computer for generating a graphical user interface to a user of the computer;
a receiving module, configured to receive information management instructions, wherein the information management instructions are generated by the computer based on user inputs through the graphical user interface; and
a managing module, configured to perform information management in the mobile device according to the information management instructions.

A computer system for managing information in a mobile device includes:

one or more processors;

memory; and

one or more program modules stored in the memory and to be executed by the one or more processors, the one or more program modules further including:
a connecting module, configured to connect the computer system to a WLAN;
a receiving module, configured to receive local device management information sent by a mobile device through the WLAN;
an information control module, configured to generate a graphical user interface using the local device management information, receive user inputs through the graphical user interface, and generate information management instructions based on the user inputs; and
an information transfer module, configured to send the information management instructions to the mobile device through the WLAN, wherein the information management instructions is used by the mobile device for managing information in the mobile device.

The technical solutions of the present invention bring the following beneficial effects:

Compared with the existing technology, in the method, the apparatus, and the system for managing information in a mobile device provided by the embodiments of the present invention, the information management instructions sent through the mobile device information control website or webpage can be received, and corresponding management of the information in the mobile device according to the information management instructions is conducted without installing a mobile device driver or a mobile device information management software in other devices such as a computer, which can reduce operation steps. The process is simple, and the efficiency is greatly improved.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

To describe the technical solutions in the embodiments of the present invention more clearly, the following briefly introduces the accompanying drawings required for describing the embodiments of the present invention. Apparently, the accompanying drawings in the following description show merely some embodiments of the present invention, and persons of ordinary skill in the art may still derive other drawings from these accompanying drawings without creative efforts.

FIG. 1 is a flowchart of a method for managing information in a mobile device according to some embodiments of the present invention;

FIG. 2 is a flowchart of a method for managing information in a mobile device according to some embodiments of the present invention;

FIG. 3 is a first schematic diagram of an apparatus for managing information in a mobile device according to some embodiments of the present invention;

FIG. 4 is a second schematic diagram of the apparatus for managing information in a mobile device according to some embodiments of the present invention;

FIG. 5 is a third schematic diagram of the apparatus for managing information in a mobile device according to some embodiments of the present invention;

FIG. 6 is a schematic diagram of a system for managing information in a mobile device according to some embodiments of the present invention;

FIG. 7 is a block diagram of a network environment including a computer and a mobile device according to the system of some embodiments of the present invention; and

FIG. 8 is a schematic diagram illustrating the structure and interactions of a computer and a mobile device according to the system of some embodiments of the present invention.

### DETAILED DESCRIPTION

In order to make the objectives, technical solutions and advantages of the present invention clearer, the embodiments of the present invention are described in detail in the following with reference to the accompanying drawings.

### Example 1

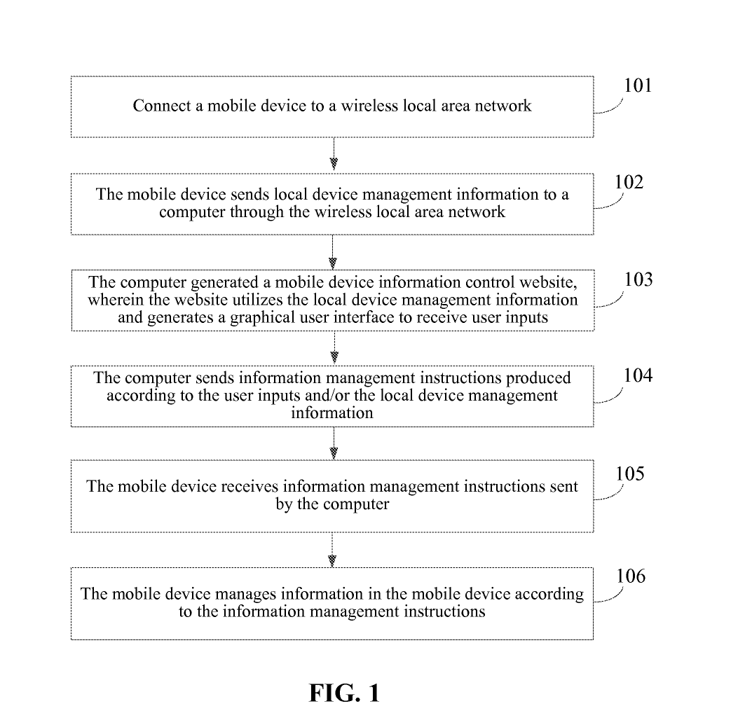

Referring to FIG. 1, an embodiment of the present invention provides a method for managing information in a mobile device, including the following steps.

101: Connect a mobile device to a computer through a wireless local area network (WLAN).

102: The mobile device sends local device management information to the computer through the WLAN.

103: The computer generates a graphical user interface utilizing the local device management information to receive user inputs.

104. The computer sends information management instructions produced according to the user inputs and/or the local device management information.

105. The mobile device receives information management instructions sent by the computer.

106: The mobile device manages information in the mobile device according to the information management instructions.

The information to be managed in the mobile device may include any information items and data, such as but not limited to files (e.g. documents, pictures, videos, and music files), programs (software), messages, and contact lists. There may be some overlap between the various information items.

The local device management information may include all kinds of information related to the information items stored on the local device and information regarding access and management of the information items. For example, the local device management information may include description of the files, programs, messages and contact lists to be managed, such as the names and location of such information items, the actions needed for them, and in what sequence should such actions be carried out. The local device management information may also include account identifiers and passwords that guard the access to the information items in the mobile device. For instance, the computer may receive local device management information that include a device ID and a password that has to be matched by the user-provided information before the computer allows the user to access the local device management information and processes the user requests associated with the local device management information.

The computer to which the local device management information may be sent can be any kind of computing device or a number of computing devices clustered by network capabilities. For example, the computer may be a single desktop or laptop computer, or a tablet computer. Alternatively, the computer may be a network-connected computer system including a number of computers. The computer may receive and store information, possibly with access to databases that are associated with the computer.

The computer includes a module to generate the graphical user interface (GUI) using the local device management information. The GUI may be used to provide the user of the computer access to the local device management information. Then, the computer generates information management instructions based on the user inputs and/or the local device management information. For instance, the information management instructions may be based on a combination of the local device management information and the user inputs through the GUI. Alternatively, the information management instructions may be generated purely according to the user inputs alone or the information management instructions alone.

The information management instructions may be sent by any computing device that is considered part of the computer. For instance, the computer may be a single computer, which receives the local device management information and sends out the information management instruction without another device. Alternatively, the computer may include more than one device wherein some devices are used for receiving information and others are used for processing and/or sending out the information management instructions.

The information management instructions are sent to the mobile device so that the mobile device may manage the information items stored in the mobile device. The instructions may point to certain information items (e.g. files, programs, contacts, and messages) and indicate what actions (e.g. saving, opening, editing, deleting, importing, exporting, installing, uninstalling, copying, cutting, and moving) should be taken for the information items.

In some embodiments, the information management instructions may be accompanied by additional identification/verification mechanisms such as identifiers and passwords. Such identifiers and passwords may be matched with entries in the mobile device, ensuring that the information in the mobile device is managed by users of the computer with appropriate authorization.

In some embodiments, the graphical user interface is part of a webpage, which provides an interface that allows the user to make entries and easily manage the information items in the mobile device. By using the local device management information, the webpage may provide a list of information items that may be selected by the user, as well as a list of actions that may be taken in response to user selections. Based on the user selections, the computer generates a set of information management instructions and sends them to the mobile device, where the actions may be carried out for the information items. The particular design of the webpage may vary according to the user's preference and previous setup. In a more specific approach, the user may enter a series of requests and instructions through the webpage to conduct the management of the information items in the mobile devices, allowing better access, higher efficiency, and more security.

Although local wireless network is used in Example 1, it should be noted that other kinds of network may also be used.

Furthermore, before being connected to a WLAN, the mobile device is configured to determine whether there is an active WLAN adjacent the mobile device.

After determining that there is an active WLAN adjacent the mobile device, the method further includes:

prompting, by the mobile device, a user of the mobile device to turn on a WLAN switch of the mobile device if no connection between the mobile device and the WLAN is established;

determining, by the mobile device, whether an instruction for turning on the WLAN switch of the mobile device is received; and

if the instruction is received, establishing, by the mobile device, a connection between the mobile device and the WLAN.

Furthermore, the step of managing the information in the mobile device based on the information management instructions comprises one or more steps selected from the group consisting of:

(a) managing files in the mobile device based on the information management instructions;

(b) managing applications in the mobile device based on the information management instructions;

(c) managing contact list in the mobile device based on the information management instructions; and

(d) managing messages in the mobile device based on the information management instructions.

In the method for managing information in a mobile device provided in the embodiments of the present invention, generic software, e.g., a web server, on the computer generates the information management instructions and sends them to the mobile device, and corresponding management of the information in the mobile device according to the information management instructions is conducted without installing a mobile device-specific driver or a mobile device-specific information management software on the computer, which can reduce operation steps. The process is simple and the efficiency is greatly improved. Moreover, the connection can be established in a network such as the WLAN instead of a data line, which can further improve management efficiency.

### Example 2

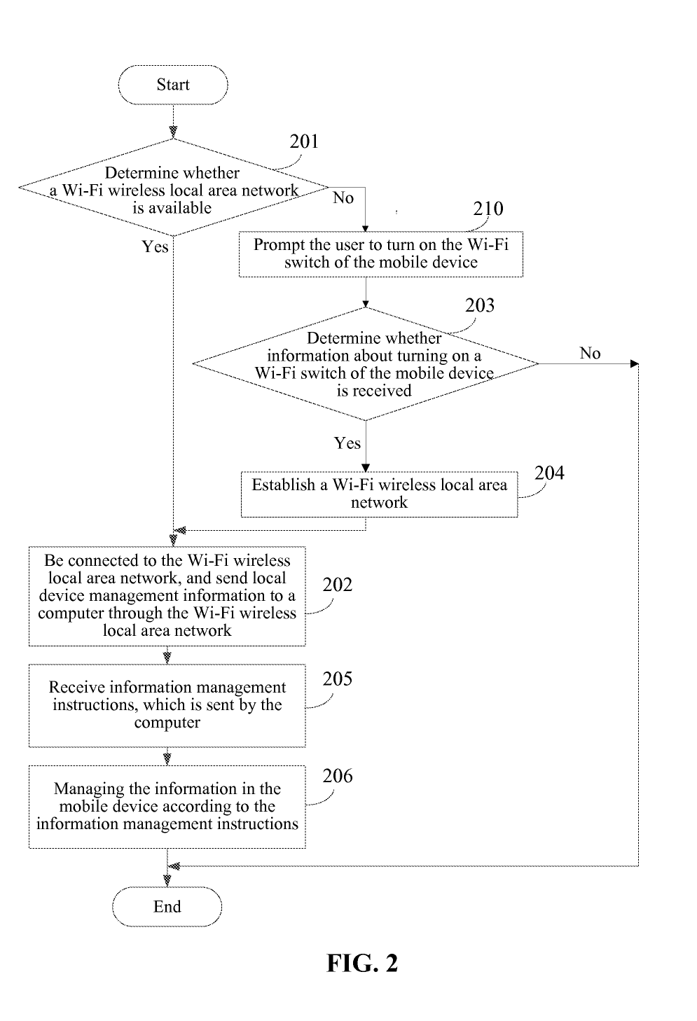

Referring to FIG. 2, an embodiment of the present invention provides a method for managing information in a mobile device, including the following steps.

201: A mobile device determines whether a Wi-Fi (Wireless Fidelity, a local area network that uses high frequency radio signals to transmit and receive data) WLAN is available, and if a Wi-Fi WLAN is available, performs 202; otherwise, performs 210—prompt the user to turn on the Wi-Fi switch of the mobile device.

Specifically, whether a Wi-Fi WLAN is available may be determined by examining whether a Wi-Fi WLAN signal can be detected by turning on a Wi-Fi switch on the mobile device. The Wi-Fi switch may be a physical or a virtual switch.

202: The mobile device is connected to the Wi-Fi WLAN, and sends local device management information to a computer through the Wi-Fi WLAN, and then performs 205.

Specifically, the mobile device may send the local device management information as one or more data packet according to the wireless communication protocols (e.g., IP protocol and Http protocol).

203: After the mobile device prompts a user to turn on the Wi-Fi switch of the mobile device (step 210), the mobile device determines whether an instruction for turning on the Wi-Fi switch of the mobile device is received, and if the instruction is received, performs 204; otherwise, the process ends.

204: The mobile device establishes a Wi-Fi WLAN, and then performs 202.

Specifically, the Wi-Fi switch of the mobile device is turned on, so that the mobile device is connected to a Wi-Fi router, so as to establish the Wi-Fi WLAN.

205: The mobile device receives, through the Wi-Fi WLAN, information management instructions, which is sent by the computer, wherein the information management instructions are generated at least in part according to the information in the webpage including user inputs.

In particular, the webpage is generated by a remote server based on the local device management information provided by the mobile device using a technology such as JSP, the webpage including a graphical user interface for receiving user inputs. The information management instructions may be generated by the remote server in accordance with the user inputs provided through the webpage and/or the local device management information.

Specifically, in some embodiments of the present invention, a WWW (World Wide Web, world wide web) network service is provided, which allows the mobile device to be accessed by other devices, such as a computer, in the same network through providing a website or webpage, so that other devices, such as a computer, process the information in the mobile device through the WWW network.

After being connected to the Wi-Fi WLAN of the mobile device, other devices, such as a computer, may access the mobile device information control website or webpage through a browser, so that a user of the computer can provide the information management instructions through the graphical user interface in the mobile device information control website or webpage, and perform remote managing on the information in the mobile device.

It should be noted that, Wi-Fi WLAN is not the only network suitable for the current invention. Other feasible networking implementations such as but not limited to Bluetooth, infrared ray, wireless network, and data line may also be used.

206: The mobile device manages information in the mobile device according to the information management instructions.

In particular, according to specifics of the information management instructions, the information management instructions may be sent to a corresponding API (application programming interface) interface of a mobile device operating system, which manages the information in the mobile device. For example, when the received information management instruction is to delete a file, the instruction is sent to an API interface for file deletion in the mobile device operating system, and the mobile device follows the instruction and deletes the file. If the received information management instruction is to sort application programs, such an instruction is sent to an API interface for application program sorting in the mobile device system operating system, and the mobile device system sorts the application programs.

In the method for managing information in a mobile device provided in the embodiments of the present invention, the information management instructions sent through the mobile device information control website or webpage can be received, and corresponding management of the information in the mobile device according to the information management instructions is conducted without installing a mobile device driver or a mobile device information management software in other devices such as a computer, which can reduce operation steps. The process is simple and the efficiency is greatly improved. Moreover, the connection can be established in a network such as the WLAN instead of a data line, which can further improve management efficiency.

### Example 3

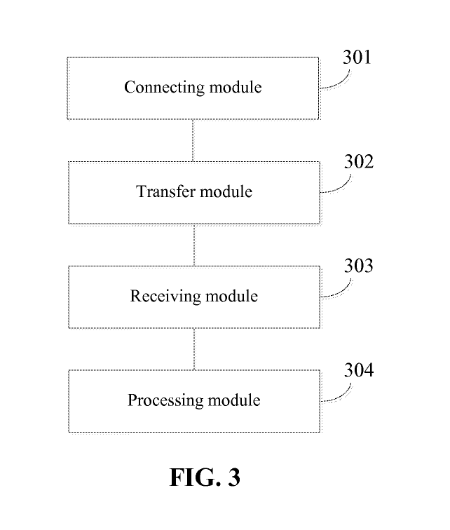

Referring to FIG. 3, an embodiment of the present invention provides an apparatus for managing information in a mobile device, which may include:

a connecting module 301, configured to connect the mobile device to a WLAN;

an information transfer module 302, configured to send local device management information of the mobile device to a computer through the WLAN, wherein the local device management information is used by the computer for generating a graphical user interface to a user of the computer;

a receiving module 303, configured to receive information management instructions, wherein the information management instructions are generated by the computer based on user inputs through the graphical user interface; and
a managing module 304, configured to perform information management in the mobile device according to the information management instructions.

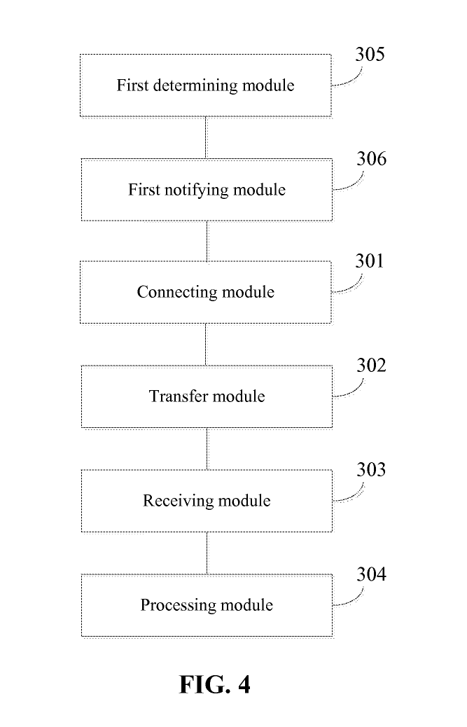

Furthermore, referring to FIG. 4, the apparatus may further include:

a first determining module 305, configured to determine whether there is an active WLAN adjacent the mobile device; and

a first notifying module 306, configured to instruct the connecting module to connect the mobile device to a WLAN.

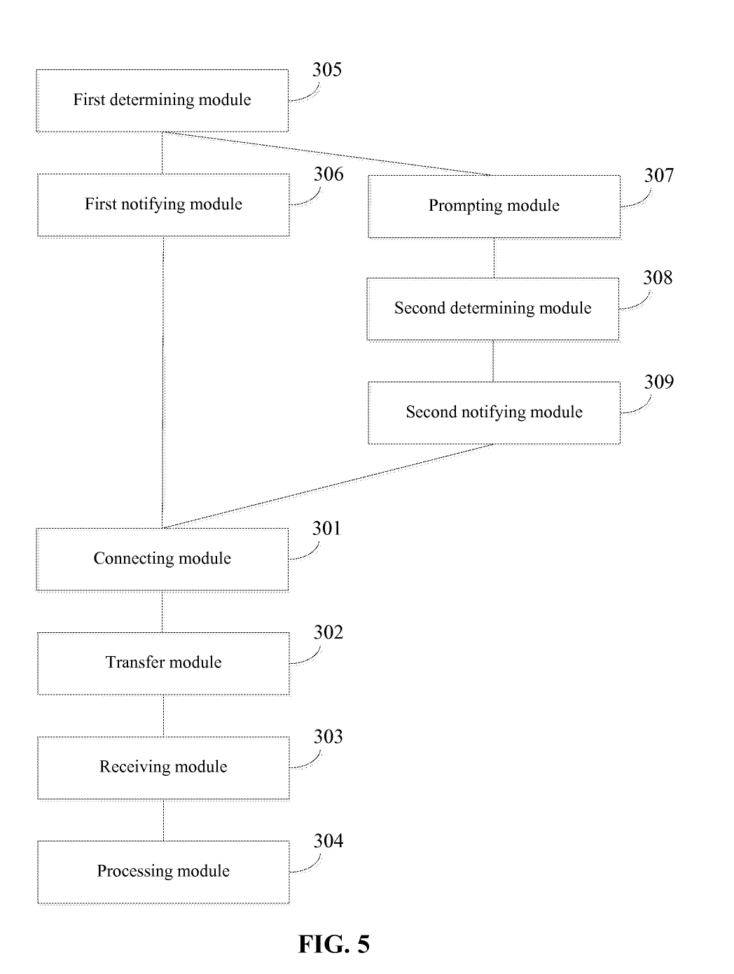

Furthermore, referring to FIG. 5, the apparatus may further include:

a prompting module 307, configured to prompt a user of the mobile device to turn on a WLAN switch of the mobile device if no connection between the mobile device and the WLAN is established;

a second processing module 308, configured to determine whether an instruction for turning on the WLAN switch of the mobile device is received; and

a second notifying module 309, configured to establish a connection between the mobile device and the WLAN.

Furthermore, the managing module is further configured to perform one or more operations selected from the group consisting of:

(a) managing files in the mobile device based on the information management instructions;

(b) managing applications in the mobile device based on the information management instructions;

(c) managing contact list in the mobile device based on the information management instructions; and

(d) managing messages in the mobile device based on the information management instructions.

It should be noted that the various modules may be associated with the mobile device where the information to be managed are stored and/or any computing device that is part of the computer to which the local device management information is sent. As indicated above, the computer may include more than one computing devices. The modules may be associated with the mobile device and/or one or more computing device of the computer. In addition, the prompting message and the notifications to the user may be displayed in any device that may effectively gain the user's attention. For example, the mobile device may be used to show the message to the user that a network has not been properly established. The computer's screen may be used to show the notification to the user to turn on the network switch.

With the apparatus for managing information in a mobile device provided in the embodiments of the present invention, the information management instructions sent through the mobile device information control website or webpage can be received, and corresponding management of the information in the mobile device according to the information management instructions is conducted without installing a mobile device driver or a mobile device information management software in other devices such as a computer, which can reduce operation steps. The process is simple and the efficiency is greatly improved. Moreover, the connection can be established in a network such as the WLAN instead of a data line, which can further improve management efficiency.

### Example 4

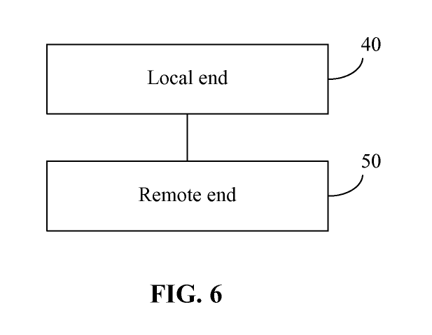

Referring to FIG. 6, an embodiment of the present invention provides a network system for managing information in a mobile device, including:

a local end 40 (e.g., a mobile device) and a remote end 50 (e.g., a computer), where

the remote end 50 includes:
a connecting module, configured to connect the computer system to a WLAN;
a receiving module, configured to receive local device management information sent by a mobile device through the WLAN;
an information control module, configured to generate a graphical user interface using the local device management information, receive user inputs through the graphical user interface, and generate information management instructions based on the user inputs; and
an information transfer module, configured to send the information management instructions to the mobile device through the WLAN, wherein the information management instructions is used by the mobile device for managing information in the mobile device;

the local end 40 includes:
a connecting module, configured to connect the mobile device to a WLAN;
an information transfer module, configured to send local device management information of the mobile device to a computer through the WLAN, wherein the local device management information is used by the computer for generating a graphical user interface to a user of the computer;
a receiving module, configured to receive information management instructions, wherein the information management instructions are generated by the computer based on user inputs through the graphical user interface; and
a managing module, configured to perform information management in the mobile device according to the information management instructions.

Furthermore, the local end 40 may further include:

a first processing module, configured to determine whether there is an active WLAN adjacent the mobile device; and

a first notifying module, configured to instruct the connecting module to connect the mobile device to a WLAN.

Furthermore, the local end 40 may further include:

a prompting module, configured to prompt a user of the mobile device to turn on a WLAN switch of the mobile device if no connection between the mobile device and the WLAN is established;

a second processing module, configured to determine whether an instruction for turning on the WLAN switch of the mobile device is received; and

a second notifying module, configured to establish a connection between the mobile device and the WLAN.

Furthermore, the remote end 50 may further include:

a web server module, configured to generate a webpage according to the local device management information, the webpage including the graphical user interface; and

a web browser module, configured to render the webpage, wherein the webpage is used for generating the information management instructions according to the user inputs and/or the local device management information.

Furthermore, the remote end 50 may further include:

a verification module, configured to extract a mobile device identifier from the local device management information and verify the mobile device using the mobile device identifier.

With the system for managing information in a mobile device provided in the embodiments of the present invention, the information management instructions sent through the mobile device information control website or webpage can be received, and corresponding management of the information in the mobile device according to the information management instructions is conducted without installing a mobile device driver or a mobile device information management software in other devices such as a computer, which can reduce operation steps. The process is simple and the efficiency is greatly improved. Moreover, the connection can be established in a network such as the WLAN instead of a data line, which can further improve management efficiency.

### Example 5

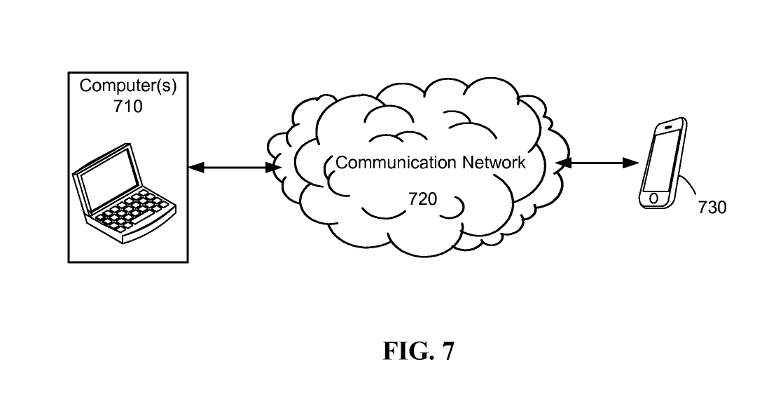

FIG. 7 is a block diagram of a network environment including a computer and a mobile device according to the system of some embodiments of the present invention. Shown in FIG. 7 is a mobile device 730 connected to a computer 710 through a communication network 720.

As indicated above, the communication network 720 may be established with any kind of network and signal transferring protocols such as but not limited to Wi-Fi, Bluetooth®, and infrared. The communication network 720 may be a wide area network (e.g. 3G or 4G mobile communication technology) or a local area network (e.g. Wi-Fi). The communication network 720 is also preferably a wireless network, avoiding the use of data lines to manage information on the mobile device 730.

The information on the mobile device 730 refers to any kind of information items and data that are stored on the mobile device 730 or can be accessed and managed by the mobile device 730. Managing the information on the mobile device 730 involves any kinds of actions and operations that may affect the information items. For example, managing files such as documents and pictures may involve saving, opening; editing, deleting, copying, and moving the file; managing software programs may involving installing; opening, editing, uninstalling (deleting), copying, and moving the software programs; managing contact lists may involve saving, opening; editing, deleting, copying, importing, exporting, and moving the contact lists; managing messages may involve saving, opening; editing, deleting, copying, importing, exporting, and moving the messages. The information items and actions herein listed are only example over a great number of information and manipulations that may be covered by the current application.

To ensure that the communication network 720 is properly established before any management actions can be carried out, the current invention provide a series of checks and determination mechanisms to remind the user. For example, as indicated by the embodiments shown in FIGS. 2 and 5, if a communication network connection has not been established; the user may receive notification to turn on a network switch, wherein such as switch may be physical (e.g. power switch for a router) or virtual (e.g. set up switch for Wi-Fi). The proper connection may only be made after the network 720 is established.

In FIG. 7, the computer 710 is the only device communicating with the mobile device 730 through the communication network 720. However, as indicated above, the computer 710 may include multiple devices, wherein such a format requires further communication between the devices through networks.

### Example 6

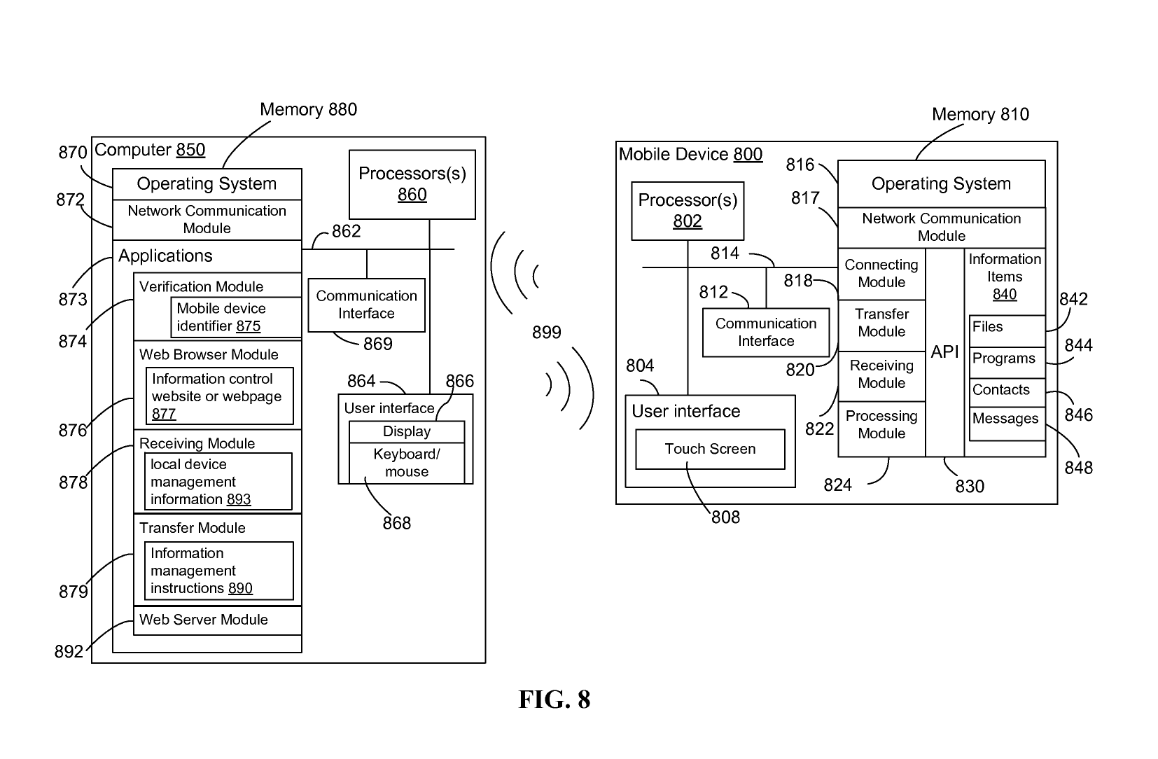

FIG. 8 is a schematic diagram illustrating the structure and interactions of a computer 850 and a mobile device 800 according to some embodiments of the present invention. Referring also to FIG. 6, the computer 850 may be considered to incorporate, in all or in part, the remote end, and the mobile device 800 may be considered to incorporate, in all or in part, the local end.

While certain specific features are illustrated, those skilled in the art will appreciate from the present disclosure that various other features have not been illustrated for the sake of brevity and so as not to obscure more pertinent aspects of the implementations disclosed herein. To that end, the mobile device 800 may include one or more mobile device processors (CPU's) 802, one or more network or other mobile device communications interfaces 812, a mobile device user interface 804 including a display and an input wherein the display and input may be consolidated to a touch screen 808, a mobile device memory 810, and one or more mobile device communication buses 814 for interconnecting these and various other components. The mobile device communication buses 814 may include circuitry (sometimes called a chipset) that interconnects and controls communications between different components. The mobile device memory 810 may include high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The mobile device memory 810 may optionally include one or more storage devices remotely located from the mobile device processor(s) 802. The mobile device memory 810, including the non-volatile and volatile memory device(s) within the mobile device memory 810, comprises a non-transitory computer readable storage medium.

In some implementations, the mobile device memory 810 or the non-transitory computer readable storage medium of the mobile device memory 810 stores the following programs, modules and data structures, or a subset thereof including an mobile device operating system 816, a mobile device network communication module 817, and one or more modules. The operating system 816 includes procedures for handling various basic system services and for performing hardware dependent tasks. The network communication module 817 facilitates communication with other devices via the one or more communication networks 812 and one or more communication networks 899 (preferably wireless), such as wide area networks, local area networks, metropolitan area networks, and so on.

The mobile device memory 810 may also include a connecting module 818, a transfer module 820, a receiving module 822, and a processing module 824, wherein the connecting module 818 is configured to connect the mobile device 800 to the network 899, the transfer module 820 is configured to send mobile device management information of the mobile device 800 to a computer 850 through the network 899, a receiving module 822 configured to receive information management instructions sent through a mobile device information control website or webpage, wherein the website utilizes the local device management information and generates a graphical user interface, and a processing module 824 configured to perform information management in the mobile device according to the information management instructions.

The information management instructions are sent to the API 830 (application programming interface), wherein the API 830 may perform certain actions on the information items 840 stored in the mobile device memory 810 according to the instructions. The information items 840 may include at least any one or a combination of: files 842, programs 844, contacts 846, and messages 848. As indicated above, the various information items 840 may partly overlap.

The touch screen 808 of the user interface 804 provides both a display and an input interface. The user of the mobile device 800 may make entries and selections through the touch screen 808 and the monitor the actions on the information items 840 in the mobile device 800.

The computer 850 may include one or more computer processors (CPU's) 860, one or more network or other computer communications interfaces 869, a computer user interface 864 including a computer display 866 and a computer input (e.g. keyboard/mouse 868), a computer memory 880, and one or more computer communication buses 862 for interconnecting these and various other components. The computer communication buses 862 may include circuitry (sometimes called a chipset) that interconnects and controls communications between different components. The computer memory 880 may include high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The computer memory 880 may optionally include one or more storage devices remotely located from the processor(s) 860. The computer memory 880, including the non-volatile and volatile memory device(s) within the computer memory 880, may comprise a non-transitory computer readable storage medium.

In some implementations, the computer memory 880 or the non-transitory computer readable storage medium of the computer memory 880 stores the following programs, modules and data structures, or a subset thereof including a computer operating system 870, a computer network communication module 872, and one or more applications 873. The operating system 870 includes procedures for handling various basic system services and for performing hardware dependent tasks. The network communication module 872 facilitates communication with other devices (e.g. the mobile device 800) via the one or more communication networks 899 (preferably wireless), such as wide area networks, local area networks, metropolitan area networks, and so on.

The applications 873 include a receiving module 877 for receiving the local device management information from the mobile device 800, a verification module 874 that verifies the mobile device 800 by extracting a mobile device identifier 875 from the local device management information 893, a web browser module 876 that generates information control website or webpage 877 using the local device management information, and an information transfer module 879 that send information management instructions 890 to the mobile device 800.

In some embodiments, the applications 873 further include a web server module 892. The web server module 892 is responsible for generating the information control website or webpage 877 based on the local device management information 893 and then collecting user inputs through the web browser module 876. Such user inputs, along with the local device management information 893 in at least some cases, are used for generating the information management instructions 890. In some other embodiments, the applications 873 shown in FIG. 8 are distributed among multiple computers, including a client computer for rendering the webpage and receiving user inputs and a server computer interfacing both the client computer and the mobile device through wireless or wired connections or both. In this case, both the local device management information 893 and the information management instructions 890 may be routed through the server computer before reaching their respective destinations in an appropriate format. The server computer is configured to convert the incoming information from the mobile device or the client computer into a different format acceptable by the client computer or the mobile device.

In some implementations, the local device management information includes information items that allow the user to verify that the device to be managed is the intended device. In such cases, a mobile device identifier 875, and optionally a password may be extracted from the local device management information sent by the mobile device 800. The sever processor(s) 860 are used by the sever verification module 874 to process the mobile device identifier 875 (an possibly the password) by searching a database. If the mobile device identifier 875 matches the record in the database, the management of information on the mobile device 800 may continue. Otherwise the process will be stopped.

The web browser module 876 may generate a mobile device information control website or webpage 877, wherein may produce a GUI to receive user inputs. The GUI may utilize the sever user interface 864 to allow the user to make entries or selection that may become part or all of the information management instructions. The information management instructions may be based on the user inputs and/or the local device management information and information management instructions may be sent by the sever transfer module 879 and received by the receiving module 822 of the mobile device 800.

The order of the examples shown here is merely for the convenience of description, not for any indication of superiority or inferiority.

Persons of ordinary skill in the art may understand that all or a part of the steps of the foregoing embodiments may be implemented through hardware, or may be implemented by a program instructing relevant hardware. The program may be stored in a computer readable storage medium. The storage medium may be a read-only memory, a magnetic disk, or an optical disk or the like.

The above descriptions are merely exemplary embodiments of the present invention, but are not intended to limit the present invention. Any modification, equivalent replacement, or improvement made without departing from the spirit and principle of the present invention should fall within the protection scope of the present invention.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method for managing information in a mobile device having one or more processors and memory for storing program modules to be executed by the one or more processors, wherein the mobile device is connected to a computer through a wireless local area network (WLAN), the method comprising:
sending, by the mobile device, local device management information to the computer through the WLAN, wherein the local device management information is used by the computer for generating a graphical user interface to a user of the computer;
receiving, by the mobile device, information management instructions, wherein the information management instructions are generated by the computer based on user inputs through the graphical user interface; and
managing, by the mobile device, information in the mobile device according to the information management instructions.

2. The method according to claim 1, wherein the mobile device is configured to determine whether there is an active WLAN adjacent the mobile device before the operations recited in claim 1.

3. The method according to claim 2, after determining that there is an active WLAN adjacent the mobile device, the method further comprising:
prompting, by the mobile device, a user of the mobile device to turn on a WLAN switch of the mobile device if no connection between the mobile device and the WLAN is established;
determining, by the mobile device, whether an instruction for turning on the WLAN switch of the mobile device is received; and
if the instruction is received, establishing, by the mobile device, a connection between the mobile device and the WLAN.

4. The method according to claim 1, wherein the step of managing the information in the mobile device according to the information management instructions comprises one or more steps selected from the group consisting of:
(a) managing files in the mobile device based on the information management instructions;
(b) managing applications in the mobile device based on the information management instructions;
(c) managing a contact list in the mobile device based on the information management instructions; and
(d) managing messages in the mobile device based on the information management instructions.

5. The method according to claim 1, wherein the local device management information includes a mobile device identifier of the mobile device.

6. The method according to claim 1, wherein the graphical user interface is part of a webpage rendered by a web browser running on the computer.

7. An apparatus for managing information in a mobile device, comprising:
one or more processors;
memory; and
one or more modules stored in the memory and to be executed by the one or more processors, the one or more modules including:
a connecting module, configured to connect the mobile device to a WLAN;
an information transfer module, configured to send local device management information of the mobile device to a computer through the WLAN, wherein the local device management information is used by the computer for generating a graphical user interface to a user of the computer;
a receiving module, configured to receive information management instructions, wherein the information management instructions are generated by the computer based on user inputs through the graphical user interface; and
a managing module, configured to perform information management in the mobile device according to the information management instructions.

8. The apparatus according to claim 7, wherein the one or more modules further include:
a first processing module, configured to determine whether there is an active WLAN adjacent the mobile device; and
a first notifying module, configured to instruct the connecting module to connect the mobile device to a WLAN.

9. The apparatus according to claim 7, wherein the one or more modules further include:
a prompting module, configured to prompt a user of the mobile device to turn on a WLAN switch of the mobile device if no connection between the mobile device and the WLAN is established;
a second processing module, configured to determine whether an instruction for turning on the WLAN switch of the mobile device is received; and
a second notifying module, configured to establish a connection between the mobile device and the WLAN.

10. The apparatus according to claim 7, wherein the managing module is further configured to perform one or more operations selected from the group consisting of:
(a) managing files in the mobile device based on the information management instructions;
(b) managing applications in the mobile device based on the information management instructions;
(c) managing a contact list in the mobile device based on the information management instructions; and
(d) managing messages in the mobile device based on the information management instructions.

11. A computer system comprising:
one or more processors;
memory; and
one or more program modules stored in the memory and to be executed by the one or more processors, the one or more program modules further including:
a connecting module, configured to connect the computer system to a WLAN;
a receiving module, configured to receive local device management information sent by a mobile device through the WLAN;
an information control module, configured to generate a graphical user interface using the local device management information, receive user inputs through the graphical user interface, and generate information management instructions based on the user inputs; and
an information transfer module, configured to send the information management instructions to the mobile device through the WLAN, wherein the information management instructions is used by the mobile device for managing information in the mobile device.

12. The system according to claim 11, wherein the one or more program modules further include:
a web server module, configured to generate a webpage according to the local device management information, the webpage including the graphical user interface; and
a web browser module, configured to render the webpage.

13. The system according to claim 11, wherein the one or more program modules further include:
a verification module, configured to extract a mobile device identifier from the local device management information and verify the mobile device using the mobile device identifier.
